(19) United States
(12) Patent Application Publication
(10) Pub. No.: US 2021/0195256 A1
(43) Pub. Date: Jun. 24, 2021

(54) DECODER EQUIPMENT WITH TWO AUDIO LINKS

(71) Applicant: SAGEMCOM BROADBAND SAS, Rueil Malmaison (FR)

(72) Inventor: Gabriel BOUVIGNE, Rueil Malmaison (FR)

(21) Appl. No.: 17/125,702

(22) Filed: Dec. 17, 2020

(30) Foreign Application Priority Data
Dec. 18, 2019 (FR) 1914786

(51) Int. Cl. H04N 21/2368; H04N 21/462; H04N 21/2365; H04N 21/236; H04N 9/804

(52) U.S. Cl. CPC H04N 21/2368; H04N 21/4622; H04N 9/8042; H04N 21/23611; H04N 21/2365

(57) ABSTRACT

Decoder equipment includes a first output suitable for connecting to audio playback equipment, a second output suitable for connecting to video playback equipment, processor means configured to use a first audio link of the first output to deliver a first audio signal coming from an incoming audio/video stream received by the decoder equipment, and to use a second audio link to deliver a second audio signal associated with at least one sound generated by the decoder equipment. The first link presents first characteristics imparting a first latency to the first audio signal and the second link presents second characteristics imparting a second latency, lower than the first latency, to the second audio signal.

The invention relates to the field of audio/video playback via one or more pieces of playback equipment.

### BACKGROUND OF THE INVENTION

Nowadays, in modern home multimedia installations, it is very frequent for decoder equipment, of the set-top box (STB) type, to be connected both to audio/video playback equipment and also to one or more pieces of audio playback equipment that are distinct from the audio/video playback equipment, for the purpose of improving a user's listening experience during playback of audio/video content.

Conventionally, the decoder equipment attempts to minimize the latency between the instant at which an incoming audio/video stream is received and the instant at which a video signal coming from said incoming stream is delivered to the audio/video playback equipment.

In addition, the decoder equipment also attempts to minimize the latency between the instant at which a user requests an action on a navigation interface (such as going from channel N to channel N+1) and:
the instant at which the action takes place (e.g. changing channel) in order to respond as quickly as possible to user requests;
the instant at which sound feedback is issued so that the user understands that the request for action has indeed been taken into account (e.g. a beep marking the change from one channel to another).

This sound feedback function is also known as “auditory feedback”, and in order to be of use it needs to be executed quickly (i.e. it needs to be associated with low latency). Specifically, it must, for example, enable a visually handicapped user to obtain confirmation that a request for action has been taken into account. If the latency is too high, the user will think, wrongly, that the request for action (e.g. a press on a button of a remote control) has not been taken into account, and then runs the risk of repeating the request (e.g. by pressing again on a button), thereby having the effect of leading to execution of an additional action that is unwanted.

Furthermore, present additional audio playback equipment, such as smart loudspeakers, nowadays operates for the most part via a wireless protocol (Wi-Fi, Bluetooth, . . . ) so it is preferable to associate such equipment with a buffer memory of large size in order to be as robust as possible against potential disturbances of the wireless connection, which disturbances may have a variety of origins (a disturbance associated with switching on an appliance that interferes with the signal—e.g. a neon starter —, transmission of a wireless signal over a different network using a channel close to the transmission channel of the decoder equipment under consideration, . . . ). The greater the size of the buffer memory, the better its robustness, but also the higher the latency between the instant at which an incoming audio/video stream is received and the instant at which sound is emitted by the loudspeaker.

Consequently, using a loudspeaker that is connected to decoder equipment via a wireless protocol (Wi-Fi, Bluetooth, . . . ), which also serves to provide sound feedback, leads to conflicting latency constraints between having a buffer memory of large size and emitting sound feedback quickly.

In order to mitigate that problem, proposals have been made to have latency for audio signals that is not too high (so as to avoid disturbing sound feedback) while still being not too low (so as to impart a degree of robustness to the wireless transmission). Present decoder equipment thus operates with an average latency of about 300 milliseconds (ms) that is not ideal either for sound feedback or for wireless transmission between the decoder equipment and the smart loudspeaker.

### OBJECT OF THE INVENTION

An object of the invention is to propose decoder equipment that provides a wireless smart loudspeaker with a better compromise in terms of latency for sound feedback and for playing back sound associated with a video.

### SUMMARY OF THE INVENTION

In order to achieve this object, the invention provides decoder equipment comprising:
a first output suitable for connecting to audio playback equipment;
a second output suitable for connecting to video playback equipment;
processor means configured to use a first audio link of the first output to deliver a first audio signal coming from an incoming audio/video stream received by the decoder equipment, and to use a second audio link to deliver a second audio signal associated with at least one sound generated by the decoder equipment, the first link presenting first characteristics imparting a first latency to the first audio signal and the second link presenting second characteristics imparting a second latency, lower than the first latency, to the second audio signal.

Thus, the invention enables audio rendering to be split into two portions: the first portion generating sound associated with video played back by the video playback equipment and the second portion creating sound feedback associated with at least one sound generated by the decoder equipment, each portion being processed by the decoder equipment in order to be associated with audio signals having different latencies. As a result, the second portion may be associated with latency that is lower than that of the first portion, thereby enabling both the “sound feedback” function (also known as “auditory feedback”) to be applied better.

The at least one sound generated by the decoder equipment may be of various different origins, and for example it may be generated in response to a user requesting an action by means of a navigation interface (a request to change channel, to run a video, . . . ), or in response to running an application of the interactive television type, or indeed in order to provide a notification (e.g. sound volume too loud, viewing time too long, . . . ). In general manner, the sound feedback could be any sound generated by the decoder equipment.

It should be understood that the sound generated by the decoder equipment is generated for the purpose of providing sound feedback so as to interact with the user. The sound generated by the decoder equipment should thus be distinguished from the sound coming from the incoming audio/video stream, which might potentially be processed by the decoder equipment, but which is not created by said decoder equipment. The first audio signal and the second audio signal thus convey sound information of different kinds.

The processor means enable audio rendering that is to be heard by a user to be split into two portions: a first portion generating sound associated with video being played back by the video playback equipment, and a second portion creating sound feedback associated with the sound generated by the decoder equipment, each portion being processed by the decoder equipment in order to be associated with respective audio signals having different latencies.

The first latency is defined by a time interval between the instant at which the processor means receive the incoming audio/video stream and the instant at which a multimedia sound associated with said incoming audio/video stream is played by the audio playback equipment, and the second latency is defined by a time interval between the instant at which the processor means receive an order for the decoder equipment to generate a sound and the instant at which said sound is played by the audio playback equipment or by the audio/video playback equipment.

The order to generate a sound may be external to the decoder equipment, for example it may be a request for action made by a user via a navigation interface (a request to change channel, to run a video, . . . ) and/or it may be internal to the decoder equipment, for example being generated by the processor means themselves (e.g. on running an application of the interactive television type or indeed for the purpose of providing a notification (e.g. sound volume too loud, viewing time too long, . . . )).

Optionally, the first audio link and the second audio link are delivered via the same first output.

Optionally, the first audio link is delivered via the first output and the second audio link is delivered via the second output.

Optionally, both audio links are configured using the same protocol.

Optionally, both audio links are configured with the same coding/decoding formats for the signals conveyed by them.

Optionally, the second latency is lower than 50 ms.

Optionally, the second latency is lower than 30 ms.

Optionally, the equipment is configured so that the first video signal is desynchronized in part or in full relative to the second audio signal.

Optionally, the equipment is configured to display a transition screen during a time for loading a video signal.

Optionally, the transition screen is a still image coming from the video signal.

The invention also provides audio playback equipment configured to be connected via a single communication channel to decoder equipment as specified above and to process the signals coming from the two audio links conveyed in said communication channel.

The invention also provides decoder equipment and audio playback equipment as specified above.

The invention also provides a method of managing two sound links, the method being performed by decoder equipment as specified above.

The invention also provides a computer program including instructions for causing the decoder equipment as specified above to execute the method as specified above.

The invention also provides a computer readable storage medium on which the above-specified computer program is stored.

Other characteristics and advantages of the invention appear on reading the following description of particular, nonlimiting embodiments of the invention.

### BRIEF DESCRIPTION OF THE DRAWINGS

The invention can be better understood in the light of the following description given with reference to the accompanying figures, in which:

FIG. 1 is a diagram showing an installation comprising decoder equipment in a first embodiment of the invention;

FIG. 2 is a flow chart showing how audio rendering is managed in the installation shown in FIG. 1;

FIG. 3 is a diagram showing how video rendering is separated by the decoder equipment shown in FIG. 1;

FIG. 4 shows successive displays on video playback equipment of the installation shown in FIG. 1 while a user is channel-hopping, and without intervention by the decoder equipment;

FIG. 5 is an image similar to that of FIG. 4, but with intervention of the decoder equipment in a first variant;

FIG. 6 is an image similar to that of FIG. 5, but with intervention of the decoder equipment in a second variant;

FIG. 7 is an image similar to that of FIG. 5, but with intervention of the decoder equipment in a third variant;

FIG. 8 is a timing diagram showing the major steps performed in the third variant for which the corresponding displays are shown in FIG. 7;

FIG. 9 is a diagram showing an installation comprising decoder equipment in a second embodiment of the invention.

### DETAILED DESCRIPTION OF THE INVENTION

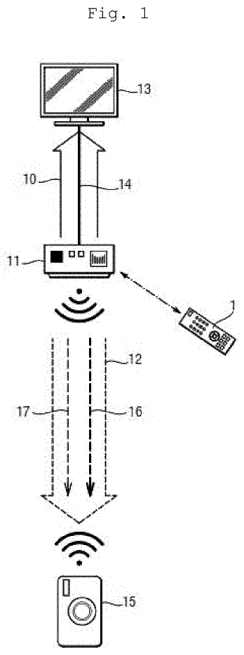

With reference to FIG. 1, the installation in a first embodiment is a multimedia installation comprising decoder equipment 11 that is connected in this example both to video playback equipment, specifically both to a piece of audio/video playback equipment 13, and also to a piece of audio playback equipment 15. The piece of audio playback equipment 15 is not included in the decoder equipment 11: they form two distinct entities that are in wireless communication.

In this example, the decoder equipment 11 is a set-top box, the piece of audio/video playback equipment 13 is a television set, and the piece of audio playback equipment 15 is an external loudspeaker.

In service, the decoder equipment 11 acquires an incoming multimedia stream from a communication interface of the decoder equipment 11, which stream may come from one or more broadcast networks. The broadcast networks may be of any type. For example, the broadcast network may be a satellite television network, with the decoder equipment 11 receiving the incoming multimedia stream via a parabolic antenna. In a variant, the broadcast network may be an Internet connection, with the decoder equipment 11 receiving the incoming multimedia stream via said Internet connection. In another variant, the broadcast network may be a digital terrestrial television (DTT) network or a cable television network. Overall, the broadcast network may be a variety of sources: satellite, cable, Internet protocol (IP), DTT, a video stream stored locally or on a local area network (LAN), etc.

In particular manner, the incoming multimedia stream received by the decoder equipment 11 comprises both metadata and also an incoming audio/video stream having an audio portion and a video portion that are synchronized with each other.

The decoder equipment 11 includes processor means serving, amongst other things, to process the incoming audio/video stream.

The audio/video playback equipment 13 is connected to an audio/video output of the decoder equipment 11. The audio playback equipment 15 is connected to an audio output of the decoder equipment 11. The term “audio/video output” is used to mean an output on which the decoder equipment 11 applies at least one audio/video signal in order to perform both audio playback and video playback via (at least) one piece of audio/video playback equipment 13 (specifically the television set). The term “audio output” is used to mean an output on which the decoder equipment 11 applies at least one audio signal in order to perform audio playback via (at least) one piece of audio playback equipment 15 (specifically the external loudspeaker).

In this first embodiment, the decoder equipment 11 acts over a single audio output to deliver both a first audio signal via a first audio link 16 and also a second audio signal via a second audio link 17.

Consequently, in corresponding manner, the audio playback equipment 15 includes processor means specific thereto for processing the first audio signal and the second audio signal delivered by the decoder equipment 11, which signals are both received via a communication interface of the audio playback equipment 15.

Furthermore, the decoder equipment 11 acts via a single audio/video link 14 to deliver an audio/video signal to the audio/video playback equipment 13.

The communication channel 10 via which the audio/video link passes between the decoder equipment 11 and the audio/video playback equipment 13 may be wired or wireless. Any type of technology may be used for making this channel 10: optical, radio, etc. The channel 10 may thus be of various different “physical” kinds (e.g. high-definition multimedia interface (HDMI), Toslink, RCA, etc.) and/or it may use various different “computer” protocols (e.g. Bluetooth, UPnP, Airplay, Chromecast, Wi-Fi, etc.).

The communication channel 12 between the decoder equipment 11 and the audio playback equipment 15, via which the first and second audio links 16 and 17 pass, is wireless. Any type of technology may be used for making this channel 12: optical, radio, etc. The channel 12 may thus use various different “computer” protocols (e.g. Bluetooth, UPnP, Airplay, Chromecast, Wi-Fi, etc.).

Thus, and in accordance with a nonlimiting option, the audio/video playback equipment 13 is an HDMI connection (i.e. the communication channel 10 is an HDMI cable) with the decoder equipment 11, and the audio playback equipment 15 is connected to the decoder equipment 11 by a local network. By way of example, the local network may be a wireless network of Wi-Fi type (i.e. the communication channel 12 is a Wi-Fi link). In another variant, the local network includes a Wi-Fi router, the decoder equipment 11 is connected to said Wi-Fi router via a wired connection of Ethernet type, and the Wi-Fi router is connected to the audio playback equipment 15 via a wireless connection of Wi-Fi type.

It should thus be understood that in the installation, two different audio links 16 and 17 between the decoder equipment 11 and the audio playback equipment 15 both pass via the same communication channel 12. Thus, a single transceiver unit provides two different audio links 16 and 17 between the decoder equipment 11 and the audio playback equipment 15. Thus, a single piece of audio playback equipment 15 serves to emit sound coming from two audio links 16 and 17.

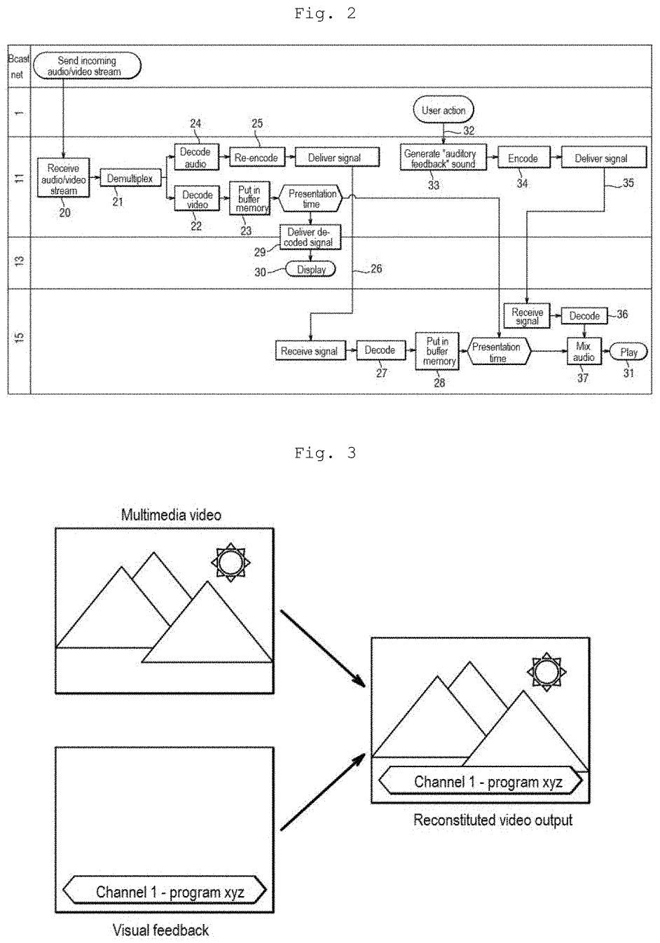

With reference to FIGS. 1 and 2, there follows a description of how the decoder equipment 11 operates.

In terms of audio rendering, the decoder equipment 11 distinguishes between two portions:
sound feedback associated with sounds generated by the decoder equipment (e.g. following a request for action issued by the user via the navigation interface 1);
multimedia sound for playing back the incoming audio stream.

In the present example, the navigation interface 1 is a remote control, but it could equally well be a pointer, a joystick, . . . . By way of example, the sound feedback may comprise emitting a beep each time the user presses on one of the buttons of the remote control.

In service, the decoder equipment 11 receives 20 the incoming audio/video stream, which is then split 21 into an audio signal and a video signal. The video signal is decoded 22 and then the corresponding “multimedia video” signal is put into buffer memory 23 in the decoder equipment 11. In contrast, the audio signal is decoded 24 to provide a “multimedia sound” signal and it is then re-encoded 25 and delivered 26 to the audio playback equipment 15 via the wireless link before being decoded 27 again by said audio playback equipment 15 and then put into buffer memory 28 in the audio playback equipment 15. In order to ensure that the “multimedia video” signal and the “multimedia sound” signal are synchronized, the video and audio data in the buffer memory is output simultaneously at a given presentation time: the “multimedia video” signal is delivered 29 to the audio/video playback equipment 13 in order to be displayed 30, and the “multimedia sound” signal is played 31 by the audio playback equipment 15.

It can happen that the user presses on a button of the navigation interface 1 in order to request an action (e.g. change channel). A control signal is then delivered 32 to the processor means, which process said signal so as to generate 33 and encode 34 a “sound feedback” signal. This signal is then delivered 35 to the audio playback equipment 15 via the wireless link and is then decoded 36 by said audio playback equipment 15. The “sound feedback” signal is then mixed 37 with the “multimedia sound” signal so that they are both played together by the audio playback equipment 15.

The decoder equipment 11 is also configured so that the “sound feedback” signal is played back with a “sound feedback” latency that is lower than the “multimedia sound” latency of the “multimedia sound” signal. In this example, the sound feedback latency is defined by the time interval between the instant at which the processor means receive the control signal from the navigation interface and the instant at which sound feedback is played by the audio playback equipment 15; while the multimedia sound latency is defined by the time interval between the instant at which the processor means receive the incoming stream and the instant at which a multimedia sound associated with said incoming stream is played by the audio playback equipment 15.

The processor means manage sound feedback in such a manner as to have a first audio link 16 of low latency, and therefore of limited quality, without any potential for retransmission or with little potential for retransmission. By way of example, the sound feedback latency may be lower than 50 ms, and is preferably lower than 30 ms.

In contrast, the processor means manage multimedia sound playback in such a manner as to have a second audio link 17 of quality that is better (in terms of sampling frequency, link dimensions, . . . ) and to guarantee better retransmission by making use of higher latency for multimedia sound. By way of example, the latency for multimedia sound lies in the range 100 ms to 2 seconds (s), and typically lies in the range 500 ms to 1 s.

It should nevertheless be understood that the latency for sound feedback cannot be lower than the incompressible latencies associated with delivering signals between the various pieces of equipment and with processing signals within the audio playback equipment 15 and the audio/video playback equipment 13.

Thus, the minimum sound feedback latency “Low_audio_latency” is defined by:

Low_audio_latency=min[(video_signal_transmission_delay+video_display_delay), (audio_transmission_delay+audio_decoding_delay+low_latency_audio_buffer)]

with:
video_signal_transmission delay: the delay for sending and receiving a video signal via the communication channel 10 between the decoder equipment 11 and the audio/video playback equipment 13;
video_display_delay: the internal display delay of the audio/video playback equipment 13;
audio_transmission_delay: the delay for sending and receiving a sound feedback signal over the first audio link 16 between the decoder equipment 11 and the audio playback equipment 15;
audio_decoding_delay: the delay for decoding the audio signal by the audio playback equipment 15;
low_latency_audio_buffer: buffer memory of predetermined latency value for the first audio link 16; (it being understood that in certain circumstances, some of the above-mentioned values may be very small, or indeed almost zero, or indeed zero).

By way of example, the “low_latency_audio_buffer” may have latency lower than 30 ms, typically lower than 5 ms.

In the same manner, multimedia sound latency cannot be lower than the incompressible latencies associated with delivering signals between the various pieces of equipment and with processing signals within the audio playback equipment 15 and the audio/video playback equipment 13.

Thus, the minimum multimedia sound latency “High_audio_latency” is defined by:

High_audio_latency=min[(video_signal_transmission_delay+video_display_delay), (audio_transmission_delay+audio_decoding_delay+high_latency_audio_buffer)]

with high_latency_audio_buffer: buffer memory of predetermined value for the second audio link 17; (it being understood that in certain circumstances, some of the above-mentioned values may be very small, or indeed almost zero, or indeed zero).

By way of example, the “high_latency_audio_buffer” may have latency in the range 0.5 s to several seconds, preferably in the range 0.5 s to 1.5 s, and for example in the range 0.5 s to 1 s.

Knowing that “high_latency_audio_buffer” latency is higher than “low_latency_audio_buffer” latency, Low_audio_latency is necessarily strictly lower than High_audio_latency.

Two audio links 16 and 17 are thus indeed obtained that have different latencies while passing via the same communication channel 12.

Audio signals may be delivered via this common communication channel 12 by using any known protocol (hypertext transfer protocol (http); real-time transport protocol/real time streaming protocol (RTP/RTSP); user datagram protocol (UDP) . . . ). In the present example, the same protocol is used for both audio links 16 and 17.

Naturally, it is necessary to distinguish between the buffer memories that enable multimedia sound signals to be synchronized with the multimedia video signals (on the basis of a target presentation time), and the “low_latency_audio_buffer” and “high_latency_audio_buffer” buffer memories (not shown in FIG. 2, but arranged in the processor means) that make it possible for the sound feedback signals and the multimedia sound signals to have different latencies. Thus, the use of buffer memory for audio/video synchronization takes place in the audio playback equipment, whereas the use of buffer memory associated with separating sound feedback from multimedia rendering takes place in the processor means.

With reference to FIG. 9, there follows a description of a second embodiment. This second embodiment is identical to the first embodiment, except that the audio playback equipment 15 plays multimedia sound only. By way of example, the sound feedback is thus played either directly by the audio/video playback equipment 13 or else by a second piece of audio playback equipment that is distinct from the first piece of audio playback equipment (e.g. a second loudspeaker, directly by the navigation interface, etc.). The first audio link 16 may be of various “physical” kinds (e.g. HDMI, Toslink, RCA, Sony/Philips Digital Interface (S/PIDF), analog audio output, etc.) and/or it may use various different “computer” protocols (e.g. Bluetooth, UPnP, Airplay, Chromecast, Wi-Fi, etc.).

This second embodiment is described in greater detail below.

The installation in the second embodiment is a multimedia installation comprising decoder equipment 11 that is connected in this example to video playback equipment, specifically both to a piece of audio/video playback equipment 13, and also to a piece of audio playback equipment 15. The piece of audio playback equipment 15 is not included in the decoder equipment 11: they form two distinct entities that are in wireless communication.

In this example, the decoder equipment 11 is a set-top box, the piece of audio/video playback equipment 13 is a television set, and the piece of audio playback equipment 15 is an external loudspeaker.

In service, the decoder equipment 11 acquires an incoming multimedia stream from a communication interface of the decoder equipment 11, which stream may come from one or more broadcast networks. The broadcast networks may be of any type. For example, the broadcast network may be a satellite television network, with the decoder equipment 11 receiving the incoming multimedia stream via a parabolic antenna. In a variant, the broadcast network may be an Internet connection, with the decoder equipment 11 receiving the incoming multimedia stream via said Internet connection. In another variant, the broadcast network may be a DTT network or a cable television network. Overall, the broadcast network may be a variety of sources: satellite, cable, IP, DTT, a locally stored video stream, etc.

In particular manner, the incoming multimedia stream received by the decoder equipment 11 comprises both metadata and also an incoming audio/video stream having an audio portion and a video portion that are synchronized with each other.

The decoder equipment 11 includes processor means serving, amongst other things, to process the incoming audio/video stream.

The audio/video playback equipment 13 is connected to an audio/video output of the decoder equipment 11. The audio playback equipment 15 is connected to an audio output of the decoder equipment 11. The term “audio/video output” is used to mean an output on which the decoder equipment 11 applies at least one audio/video signal in order to perform both audio playback and video playback via (at least) one piece of audio/video playback equipment 13 (specifically the television set). The term “audio output” is used to mean an output on which the decoder equipment 11 applies at least one audio signal in order to perform audio playback via (at least) one piece of audio playback equipment 15 (specifically the external loudspeaker).

In this second embodiment, the decoder equipment 11 delivers a first audio signal over the audio output via a second audio link 17.

Consequently, in corresponding manner, the audio playback equipment 15 includes processor means specific thereto for processing the second audio signal 17 that is received via a communications interface of the audio playback equipment 15.

Furthermore, the decoder equipment 11 acts both via a single audio/video link 14 to deliver an audio/video signal to the audio/video playback equipment 13, and also via a first audio link 16 to deliver a first audio signal thereto.

The communication channel 10 via which both the audio/video link 14 and also the first audio link 16 pass between the decoder equipment 11 and the audio/video playback equipment 13 may be wired or wireless. Any type of technology may be used for providing this channel: optical, radio, etc. The channel may thus be of various different “physical” kinds (e.g. HDMI, Toslink, RCA, etc.) and/or it may use various different “computer” protocols (e.g. Bluetooth, UPnP, Airplay, Chromecast, Wi-Fi, etc.).

The communication channel 12 between the decoder equipment 11 and the audio playback equipment 15, via which the second audio link 17 passes, is wireless. Any type of technology may be used for making this channel 12: optical, radio, etc. The channel 12 may thus use various different “computer” protocols (e.g. Bluetooth, UPnP, Airplay, Chromecast, Wi-Fi, etc.).

Thus, and in accordance with a nonlimiting option, the audio/video playback equipment 13 is an HDMI connection (i.e. the communication channel 10 is an HDMI cable) with the decoder equipment 11, and the audio playback equipment 15 is connected to the decoder equipment 11 by a local network. By way of example, the local network may be a wireless network of Wi-Fi type (i.e. the communication channel 12 is a Wi-Fi link). In another variant, the local network includes a Wi-Fi router, the decoder equipment 11 is connected to said Wi-Fi router via a wired connection of Ethernet type, and the Wi-Fi router is connected to the audio playback equipment 15 via a wireless connection of Wi-Fi type.

It should thus be understood that in the installation, there are two audio links 16 and 17 that are different, one between the decoder equipment 11 and the audio playback equipment 15 and the other between the decoder equipment 11 and the audio/video playback equipment 13. Also, there are two different links 14 and 16 (one audio and the other audio/video) both passing via the same communication channel 10.

There is thus still an installation having only two communication channels 10 and 12, with two audio links 16 and 17 that have different latencies.

There follows a description of how the decoder equipment 11 operates.

In terms of audio rendering, the decoder equipment 11 distinguishes between two portions:
the sound feedback associated with requests for actions made by the user via a navigation interface 1;
multimedia sound for playing back the incoming audio stream.

In the present example, the navigation interface 1 is a remote control, but it could equally well be a pointer, a joystick, . . . . By way of example, the sound feedback may comprise emitting a beep each time the user presses on one of the buttons of the remote control.

In service, the decoder equipment 11 receives the incoming audio/video stream, which is then split into an audio signal and a video signal. The video signal is decoded and then the corresponding “multimedia video” signal is put into buffer memory in the decoder equipment 11. In contrast, the audio signal is decoded to provide a “multimedia sound” signal and it is then re-encoded and delivered to the audio playback equipment 15 via the wireless link before being decoded again by said audio playback equipment 15 and then put into buffer memory in the audio playback equipment 15. In order to ensure that the “multimedia video” signal and the “multimedia sound” signal are synchronized, the video and audio data in the buffer memory is output simultaneously at a given presentation time: the “multimedia video” signal is delivered to the audio/video playback equipment 13 in order to be displayed, and the “multimedia sound” signal is played by the audio playback equipment 15.

It can happen that the user presses on a button of the remote control in order to request an action (e.g. change channel). A control signal is then delivered to the processor means, which process said signal so as to generate a “sound feedback” signal. This signal is then delivered to the audio playback equipment 15 in order to be played by the audio playback equipment 15.

The decoder equipment 11 is also configured so that the “sound feedback” signal is played back with a “sound feedback” latency that is lower than the “multimedia sound” latency of the “multimedia sound” signal. In this example, the sound feedback latency is defined by the time interval between the instant at which the processor means receive the control signal from the navigation interface 1 and the instant at which sound feedback is played by the audio/video playback equipment 13; while the multimedia sound latency is defined by the time interval between the instant at which the processor means receive the incoming stream and the instant at which a multimedia sound associated with said incoming stream is played by the audio playback equipment 15.

The processor means manage sound feedback in such a manner as to have a first audio link 16 of low latency, and therefor of limited quality, without any potential for retransmission or with little potential for retransmission. By way of example, the sound feedback latency may be lower than 50 ms, and is preferably lower than 30 ms.

In contrast, the processor means manage multimedia sound playback in such a manner as to have a second audio link 17 of quality that is better (in terms of sampling frequency, link dimensions, . . . ) and to guarantee better retransmission by making use of higher latency for multimedia sound. By way of example, the latency for multimedia sound lies in the range 100 ms to 2 s, and typically lies in the range 500 ms to 1 s.

It should nevertheless be understood that the latency for sound feedback cannot be lower than the incompressible latencies associated with delivering signals between the various pieces of equipment and with processing signals within the audio playback equipment 15 and the audio/video playback equipment 13.

Thus, the minimum sound feedback latency “Low_audio_latency” is defined by:

Low_audio_latency=min[(video_signal_transmission_delay+video_display_delay), (audio_transmission_delay+audio_decoding_delay+low_latency_audio_buffer)]

with:
video_signal_transmission delay: the delay for sending and receiving a video signal via the communication channel 10 between the decoder equipment 11 and the audio/video playback equipment 13;
video_display_delay: the internal display delay of the audio/video playback equipment 13;
audio_transmission_delay: the delay for sending and receiving a sound feedback signal over the first audio link 16 between the decoder equipment 11 and the audio/video playback equipment 13;
audio_decoding_delay: the delay for decoding the audio signal by the audio/video playback equipment 13;
low_latency_audio_buffer: buffer memory of predetermined latency value for the first audio link 16; (it being understood that in certain circumstances, some of the above-mentioned values may be very small, or indeed almost zero, or indeed zero).

By way of example, the “low_latency_audio_buffer” may have latency lower than 30 ms, typically lower than 5 ms.

In the same manner, multimedia sound latency cannot be lower than the incompressible latencies associated with delivering signals between the various pieces of equipment and with processing signals within the audio playback equipment 15 and the audio/video playback equipment 13.

Thus, the minimum multimedia sound latency “High_audio_latency” is defined by:

High_audio_latency=min[(video_signal_transmission_delay+video_display_delay), (audio_transmission_delay+audio_decoding_delay+high_latency_audio_buffer)]

with high_latency_audio_buffer: buffer memory of predetermined latency value for the second audio link 17; (it being understood that in certain circumstances, some of the above-mentioned values may be very small, or indeed almost zero, or indeed zero).

By way of example, the “high_latency_audio_buffer” may have latency in the range 0.5 s to several seconds, preferably in the range 0.5 s to 1.5 s, and for example in the range 0.5 s to 1 s.

Knowing that “high_latency_audio_buffer” latency is higher than “low_latency_audio_buffer” latency, Low_audio_latency is necessarily strictly lower than High_audio_latency.

Two audio links 16 and 17 are thus indeed obtained that have different latencies while passing via different communication channels 10 and 12.

Naturally, it is necessary to distinguish between the buffer memories that enable multimedia sound signals to be synchronized with the multimedia video signals (on the basis of a target presentation time), and the “low_latency_audio_buffer” and “high_latency_audio_buffer” buffer memories that make it possible for the sound feedback signals and the multimedia sound signals to have different latencies. Thus, the use of buffer memory for audio/video synchronization takes place in the audio playback equipment 15, whereas the use of buffer memory associated with separating sound feedback from multimedia rendering takes place in the processor means.

Two distinct embodiments of an installation and in particular of decoder equipment 11 are thus described above, but both of them make it possible to provide both a relatively low first latency for the “auditory feedback” function and also a higher second latency ensuring better robustness for playing the multimedia sound, with this being done by splitting sound rendering into two portions.

Each of the above-described embodiments presents specific features.

### First Embodiment

The audio playback equipment 15 needs to be configured to be capable of managing the fact that it is associated with the decoder equipment 11 via a single communication channel 12 that conveys two distinct audio links 16 and 17.

In contrast, the user is not surprised by the way sound is rendered.

### Second Embodiment

The audio playback equipment 15 has no need to present a particular configuration. It is thus possible to use any commercially available audio playback equipment to perform the invention.

In contrast, the user might be surprised by the way sound is rendered because it is played by equipment other than the audio playback equipment 15 that is being used to play the multimedia sound.

Whatever the intended embodiment, the sound feedback may also be associated with visual feedback. Thus, depending on the action requested by the user via the navigation interface 1, corresponding information will be displayed by the audio/video playback equipment 13. For example, if the user requests a change of channel, the information that is displayed may be of the following type: name of the new target channel, program currently being broadcast on said channel, . . . .

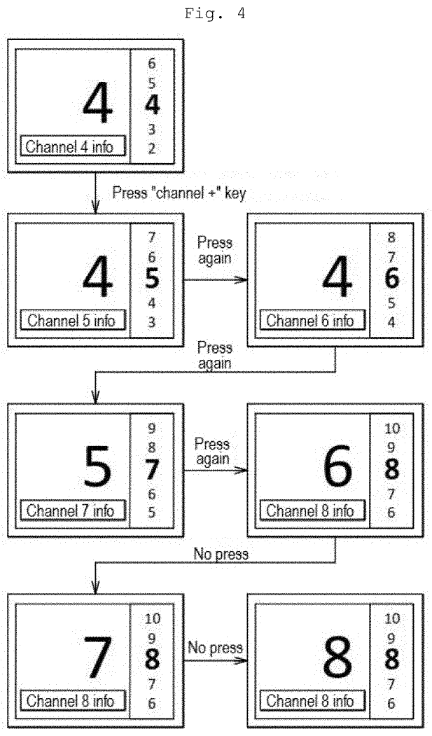

With reference to FIG. 3, the processor means are thus configured to use the audio/video communication channel 10 to deliver a single video signal made up both of multimedia video signals (coming from the incoming audio/video stream) and also of visual feedback signals.

The installation thus has passing through it both visual feedback signals synchronized with the sound feedback signals and also multimedia video signals synchronized with the multimedia sound signals. Consequently, because of the different latencies for the multimedia sound signals and for the sound feedback signals and because of the audio/video synchronization both for navigation and also for the multimedia stream, the multimedia video signals are played back with latency that is longer than those of the visual feedback.

Thus, without additional processing by the decoder equipment 11, the visual feedback and the video will not be synchronized, and that can be disturbing for a user.

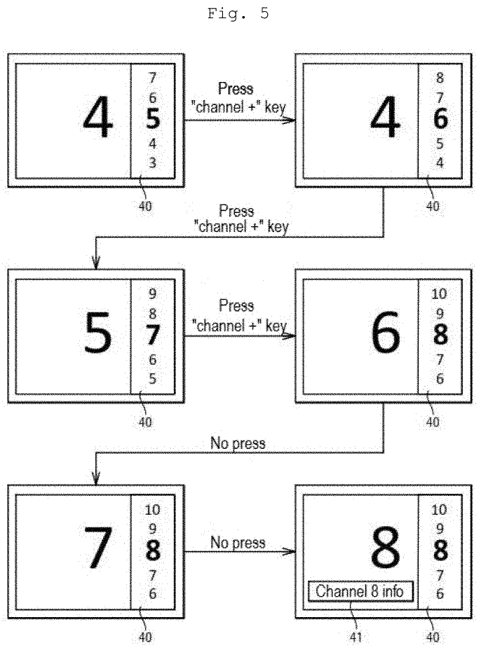

For example, when channel hopping, as shown in FIG. 4, the video will take longer to change from one channel to another than the information presented by the visual feedback (name of the channel, name of the program that can now be viewed on said channel, list of channels highlighting the number of the requested channel, . . . ).

Consequently, there is going to be an offset between the visual feedback and the video, such that the information that is presented does not correspond to the channel that is being displayed simultaneously.

In order to avoid an offset between visual feedback and multimedia video, the decoder equipment 11 is configured in a first variant to act as shown in FIG. 5.

In this first variant, the processor means desynchronize the visual feedback video signal from the sound feedback signal in order to synchronize it with the multimedia video signal.

Thus, the latency for displaying visual feedback elements is the same as the latency for displaying the multimedia video.

The equipment thus waits until the video of the requested channel is indeed being played by the audio/video playback equipment in order to display the corresponding information simultaneously. The channel being displayed is thus correlated with the channel information being displayed, thereby limiting any risk of user confusion.

It is also possible to desynchronize the visual feedback video signal either totally from the sound feedback signal in order to synchronize it with the multimedia video signal, or else to desynchronize it in part only: under such circumstances, a portion of the information will be displayed simultaneously with the sound rendering and a portion will be displayed only when the corresponding video is also being displayed.

For example, a list of channels highlighting the number of the requested channel 40 may be displayed on a side of the screen synchronously with the sound feedback signal so that the user can see clearly that the requested action has indeed been taken into account. In contrast, other information 41, such as the name of the channel, information about the program currently being broadcast by the channel, . . . will be displayed only when the corresponding video is also being displayed.

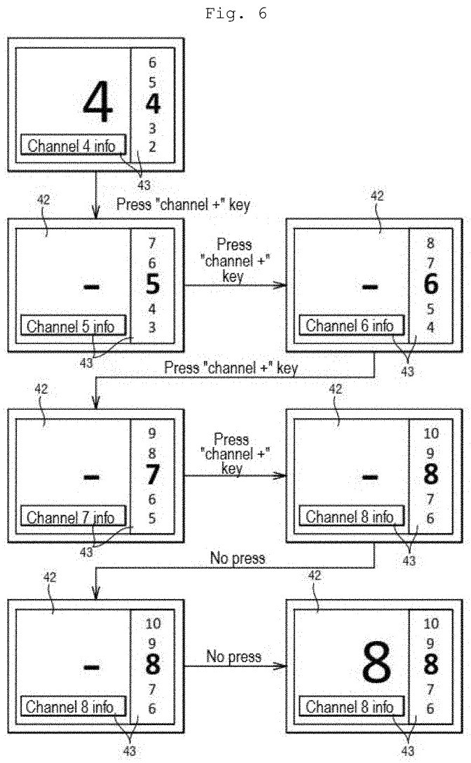

In a second variant shown in FIG. 6, in order to avoid the offset between visual feedback and multimedia video, the processor means conserve synchronization between sound feedback and visual feedback, while displaying a transition screen 42 instead of the multimedia video signal until the user ceases to act on the navigation interface. For example, while channel hopping, the transition screen 42 is displayed until the user settles on one channel. It is considered that a channel has been settled on when the time interval Δt that has elapsed since the most recent control signal is not less than “video_signal_transmission_delay+video_display_delay”.

Thereafter, the processor means launch the video of the corresponding channel.

The transition screen 42 may be a color screen, a black screen, a screen with a logo (such as the logo of the channel), an animated screen, . . . and in general manner any temporary screen background.

Consequently, the user thus has access only to the information 43 supplied by the visual feedback, which information is thus no longer in conflict with a display of multimedia video. This likewise limits any risk of user confusion.

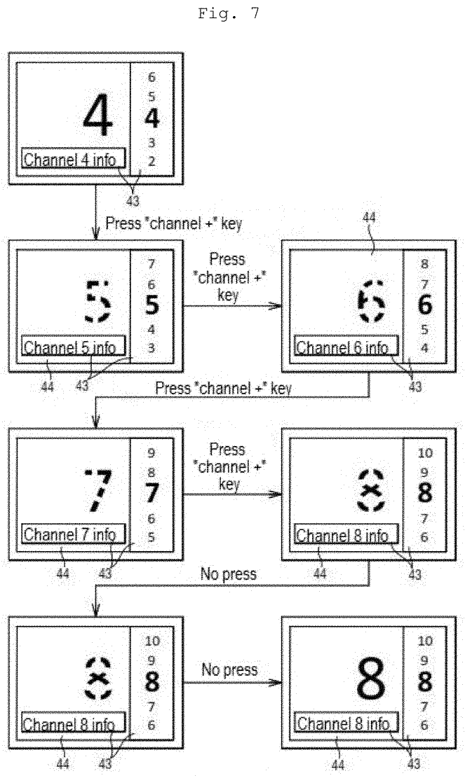

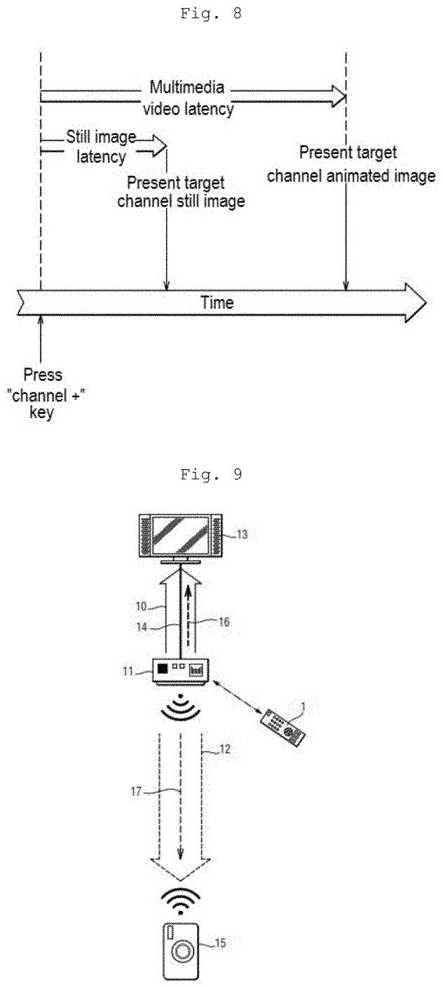

FIGS. 7 and 8 show a third variant for limiting the offset between visual feedback and multimedia video.

In this third variant, the processor means conserve synchronization between sound feedback and visual feedback, but display a still image 44 from the multimedia video signal until the user ceases to act on the navigation interface. Specifically, the decoder equipment 11 does, in fact, already have access to the video requested by the user, but it is the high latency desired for rendering multimedia sound and video that leads to the offset between visual feedback and multimedia video. In order to limit user confusion, the processor means can thus display a still image 44 very quickly if so desired (although nevertheless after the incompressible latency associated with video decoding, i.e. video_signal_transmission_delay plus video_display_delay).

For example, while channel hopping, a still image 44 is displayed until one channel has been settled on. It is considered that a channel has been settled on when the time interval Δt that has elapsed since the most recent control signal is not less than “video_signal_transmission_delay+video_display_delay”.

Consequently, the user thus has access to the information 43 supplied by the visual feedback, which information matches the still image 44 displayed by the audio/video playback equipment 13. This likewise limits any risk of user confusion.

Naturally, the invention is not limited to the embodiments described above, and variant embodiments may be provided without going beyond the ambit of the invention.

Thus, although above, the decoder equipment is a decoder box, the decoder equipment could be any other equipment capable of performing audio/video decoding such as a digital video decoder, and for example it could be a games console, a computer, a smart TV, a digital tablet, a mobile telephone, a digital television decoder, a set-top box, or an HDMI dongle, etc.

Although the video playback equipment above is audio/video playback equipment, it could be any other type of audio/video playback equipment or equipment for video playback only. The equipment could thus be a television set, a video projector, a tablet, a mobile telephone, etc. The video playback equipment and the decoder equipment could thus together form a single entity.

Likewise, although above the audio playback equipment is an external smart loudspeaker, it could be any other equipment having a loudspeaker, e.g. a sound bar, an audio system connected to a Wi-Fi/audio bridge, . . . .

The numbers of pieces of video playback equipment and/or of audio playback equipment (in particular more loudspeakers) and/or of decoder equipment could be larger than mentioned above.

The communication channel between the decoder equipment and the audio playback equipment could be different from that described, and for example it could be of Bluetooth type. With a Wi-Fi link, the link could be of dedicated type or of infrastructure type.

Although above, identical protocols are used for both audio links, it would be possible to use different protocols for each of the two audio links. For example, it would be possible to use a UDP protocol for the sound feedback link and an HTTP protocol for the multimedia audio/video link. Likewise, it would be possible to use identical or different signal coding/decoding formats for the two audio links. If the transmission protocol and/or the audio coding format differ between the two audio links, it is possible that the audio_transmission_delay and audio_decoding_delay values differ from one audio link to another. For example, a UDP/RTP protocol could have lower latency than an HTTP protocol, PCM or ADPCM sound coding could have lower decoding latency than MPEG 4, AAC, or Opus, . . . coding.

Although above there are always two communication channels for passing the three links (the two audio links and the audio/video link), with the second embodiment it is possible to envisage having two communication channels between the video playback equipment and the decoder equipment respectively for passing the first audio link and the video link (audio/video link) together with only one communication channel between the audio playback equipment and the decoder equipment.

Furthermore, although above the variants for limiting the offset between visual feedback and multimedia video are described with reference to changing channel, the above-described variants could naturally be used for other types of action requested by the user, e.g. when requesting video playback (video on demand (VOD) playback, playback of a network video stream, playback of a recording on a personal video recorder (PVR), . . . ). For example, a still image taken from decoding the video could be presented quickly, before moving on to animated video once the multimedia video latency delay has been reached, or else a transition screen could be presented.

Furthermore, although above the sound feedback is associated with an action requested by the user, the sound feedback generated by the decoder equipment could have some other origin. For example, the sound feedback could be generated in the context of an interactive television application or for the purpose of providing a notification (e.g. sound volume too loud, viewing time too long, . . . ). In general manner, the sound feedback could be any sound generated by the decoder equipment.

Furthermore, although above the incoming audio/video stream comes from outside and is received by the communication interface in order to be processed directly by the decoder equipment, the incoming audio/video stream could have been received beforehand by the communication interface and recorded locally in the decoder equipment. The decoder equipment would then subsequently process the incoming audio/video stream that has been recorded locally.

Although above the processor means are configured to use a single audio/video communication channel to deliver a single video signal made up both of multimedia video signals (coming from the incoming audio/video stream) and also of visual feedback signals, the processor means could deliver two types of video signal via a single communication channel (the multimedia video signals and the visual feedback signals): and it would then be the audio/video playback equipment that processes both types of signal in order to generate a single video signal for display.

1. Decoder equipment comprising:
a first output suitable for connecting to audio playback equipment;
a second output suitable for connecting to video playback equipment;
processor means configured to use a first audio link of the first output to deliver a first audio signal coming from an incoming audio/video stream received by the decoder equipment, and to use a second audio link to deliver a second audio signal associated with at least one sound generated by the decoder equipment of the first output or of the second output, the sound generated by the decoder equipment being distinct from a sound coming from the incoming audio/video stream, the first link presenting first characteristics imparting a first latency to the first audio signal and the second link presenting second characteristics imparting a second latency, lower than the first latency, to the second audio signal.

2. The decoder equipment according to claim 1, wherein the first audio link and the second audio link are conveyed via the same first output.

3. The decoder equipment according to claim 1, wherein the second audio link is conveyed via the second output.

4. The decoder equipment according to claim 1, wherein the two audio links are configured with different protocols.

5. The decoder equipment according to claim 1, wherein the two audio links are configured with different coding/decoding formats for the signals conveyed by them.

6. Equipment according to claim 1, wherein the second latency is lower than 50 ms.

7. The equipment according to claim 6, wherein the second latency is lower than 30 ms.

8. The equipment according to claim 1, configured to generate a video signal associated with a user requesting action.

9. The equipment according to claim 8, configured so that the first video signal is desynchronized in part or in full relative to the second audio signal.

10. The equipment according to claim 1, configured to display a transition screen during a time for loading a video signal.

11. The equipment according to claim 10, wherein the transition screen is a still image coming from the video signal.

12. Audio playback equipment configured to be connected via a single communication channel to the decoder equipment according to claim 2 and to process the signals coming from the two audio links conveyed in said communication channel.

13. An installation comprising at least the decoder equipment according to claim 2 and audio playback equipment configured to be connected via a single communication channel to the decoder equipment and to process the signals coming from the two audio links conveyed in said communication channel.

14. A method of managing two sound links, the method being performed by the decoder equipment according to claim 1.

15. A computer program including instructions for causing the decoder equipment according to claim 1 to execute a method of managing two sound links.

16. A computer readable storage medium on which the computer program according to claim 15 is stored.
